(19) United States
(12) Patent Application Publication
(10) Pub. No.: US 2021/0348784 A1
(43) Pub. Date: Nov. 11, 2021

(54) BREATHING ZONE VENTILLATION SYSTEM

(71) Applicant: Gerard Stephen Henwood, Berea, OH (US)

(72) Inventor: Gerard Stephen Henwood, Berea, OH (US)

(21) Appl. No.: 17/302,669

(22) Filed: May 10, 2021

Related U.S. Application Data
(60) Provisional application No. 63/101,632, filed on May 9, 2020.
(60) Provisional application No. 63/103,533, filed on Aug. 10, 2020.

(51) Int. Cl. F24F 9/00

(52) U.S. Cl. CPC F24F 9/00; F24F 8/108; F24F 2009/002

(57) ABSTRACT

A breathing zone ventilation system for providing a protective air barrier between closely spaced individuals within a local environment. The breathing zone ventilation system includes a plurality of seats. An air control module has a housing defining an interior cavity, a blower, and at least one air tray stage. The housing has an inlet in communication with an air inlet and outlet. The blower, contained within the housing, is configured to develop a high velocity airflow into the air inlet, defining a downdraft air curtain. The at least one air tray stage is disposed between the blower and the outlet and has a frame defining an air tray enclosure. A plurality of baffles are disposed in a spaced apart relation within the air tray enclosure to define a labyrinth pathway between the blower and the outlet. The outlet may be configured to vent clean air within the local environment.

### CROSS-REFERENCE TO RELATED APPLICATION

This application claims the benefit of priority of U.S. provisional application No. 63/101,632 filed May 9, 2020, and Ser. No. 63/103,533 filed Aug. 10, 2020, the contents of which are herein incorporated by reference.

### BACKGROUND OF THE INVENTION

The present invention relates to air barrier protection systems, and more particularly to air barrier protection systems provided in closed environments.

COVID 19 made all the world's people aware of just how dangerously vulnerable we are when it comes to invisible viruses that are spread by breathing, coughing, sneezing, speaking and singing, both indoors and outdoors. The global reaction was to isolate and distance people from each other and to shut down or reduce capacity in any public space where people congregate. Room and building ventilation is considered a viable way to disperse the virus, but it is also the cause of its spread.

Direction of airflow in a room, is largely dictated by placement of heating and cooling air-in and air-out locations can transport viruses across a room. This was demonstrated in the restaurant in Wuhan in the Chinese province of Guangzhou, when in January of 2020, first reports of Coronavirus spread emerged. Two diners seated at the same table as the infected person became infected. In what appeared random, diners over ten feet away also became infected, bypassing diners seated closer by. It was not random at all. Diners who caught the disease at that meal were either immediately nearby or seated downwind, based on which way the rooms ventilation system moved the air, from the infected person.

All of this proves that room ventilation is the culprit in spreading germs from one person to another and that there is no way that improvements to room ventilation can be reliably prevent airborne transmission of disease. This is because room ventilation moves air across a room and in doing so passes air and infectious molecules from one person to another. This has become known as “air sharing” or “air swapping”.

Introduction of supplemental air treatments like ultraviolet light or bipolar ionization, while proven to work, only do so when the air is on and moving through ductwork. There is plenty of time when air systems, based on room temperature are not producing mechanically blown heated or cooled air, thereby not ridding the air of infectious diseases during those times. Technologies claiming to charge the air with infection-killing ions have little testing in way of keeping freshly coughed or sneezed air from infecting a nearby person.

Technology for moving air in the immediate area of a person, breathing zone, is long established to reduce fumes generated from cooking, welding, cigarette smoking or manufacturing processes where noxious gas is produced that can cause dangerous respiratory and cardiovascular disease. US Patent Application Publication US 2021/0003301 A1 titled Droplet Infection Suppression System and Droplet Infection Suppression Method by Panasonic Jan. 7, 2021 and U.S. Pat. No. 9,050,382 B2 Jun. 9, 2015 by Peter Carr both disclose air curtains which use upward flowing air emanating from the center of a tabletop to prevent a person on one side of that table from infecting the person on the other side of the table.

While effective in the space of two people, this technology, is not viable in a larger congregate setting since the air flow launches infectious aerosols about the room causing them to be transmitted to a person other than the two people at the table, and arguably even to the persons at the table when the air moves about the room and recirculates to either person from any position behind the air curtain. U.S. Pat. No. 5,441,279 Aug. 15, 1995 for a Smokeless Casino Gaming Table, by Gary Messina, draws air downward but then exhaust it back into the space where people are seated producing uncontrolled air flow that can carry infectious aerosols. U.S. Pat. No. 10,393,399 B2 Targeted Clean Air Delivery Aug. 27, 2019 by Koninklijke Phillips N.V. Netherlands gathers air in and then returns it to the persons face or another targeted direction. The result, from an air disturbance perspective, like the aforementioned patents, produces secondary air movement that can transmit airborne disease from one person to another.

US Patent Application Publication US 2005/0097870 May 12, 2005 by Paul Moshenrose for Air Cleaning Furniture and U.S. Pat. No. 5,904,755 May 18, 1999 Furniture Having Air Control Functions by Tadashi Kanazashi and Kuzamasa Yonedo disclose the combination of furniture and air cleaning for a room or a space in a room, but not specifically for the breathing zone or the removal of infectious aerosols. US Patent Application Publication US 2018/0079278 A1 Vehicle Ventilation System (Variants) by Obschestvo S Ogranichennoi Otvetstvennostiyu “Autex Ltd.” Moscow discloses a sensor actuated ventilation system for vehicles vehicle interiors and cabins but, again is not necessarily in the breathing zone and only captures a portion of exhaled air.

As can be seen, there is a need for improved breathing zone ventilation system that provides an effective air barrier and filtration of particulates before dispersal of the air barrier airflow within an enclosed space.

### SUMMARY OF THE INVENTION

In one aspect of the present invention, a breathing zone ventilation system for providing a protective air barrier between closely spaced individuals within a local environment is disclosed. The breathing zone ventilation system includes an air inlet disposed between an occupant of the local environment and another occupant of the local environment. An air control module has a housing, defining an interior cavity of the air control module, a blower, and at least one air tray stage, the housing having an inlet in communication with the air inlet and an outlet. The blower is contained within the housing. The blower is configured to develop a high velocity airflow into the air inlet, defining a downdraft air curtain into the air inlet. The at least one air tray stage is disposed between the blower and the outlet. The at least one air tray stage having a frame defining an air tray enclosure, and a plurality of baffles disposed in a spaced apart relation within the air tray enclosure, the plurality of baffles defining a labyrinth pathway between the blower and the outlet.

In some embodiments, the air control module also includes a filter interposed between the air tray stage and the outlet.

In some embodiments, the air inlet is disposed in a tabletop of a table; and the air control module is mounted with a leg supporting the tabletop.

In some embodiments, the outlet is vented to the local environment proximal to the table.

In some embodiments, an air duct is coupled to the outlet. The air duct is configured to communicate an exit airflow from the outlet to a point distal from the table.

In some embodiments, the air control module is removably carried within a pedestal supporting the tabletop.

In some embodiments, a grille covers the air inlet.

In other aspects of the invention, a breathing zone ventilation system for providing a protective air barrier between closely spaced individuals within a local environment is disclosed. The breathing zone ventilation system includes a plurality of seats within the local environment. An air inlet is disposed on a seat back of each of the plurality of seats. A duct is coupled with the air inlet. An air control module has a housing defining an interior cavity of the air control module, a blower, and at least one air tray stage. The housing having an inlet in communication with the air inlet, and an outlet. The blower is contained within the housing. The blower is configured to develop a high velocity airflow into the air inlet, defining a downdraft air curtain into the air inlet. The at least one air tray stage is disposed between the blower and the outlet. The at least one air tray stage having a frame defining an air tray enclosure and a plurality of baffles disposed in a spaced apart relation within the air tray enclosure. The plurality of baffles defining a labyrinth pathway between the blower and the outlet.

In some embodiments, the air control module also includes a filter interposed between the air tray stage and the outlet of the air control module.

In some embodiments, the air control module is mounted in a space beneath the plurality of seats.

In some embodiments, a duct interposed between the air inlet and the air control module.

In some embodiments, wherein the outlet is in communication with an air circulation system of the local environment.

These and other features, aspects and advantages of the present invention will become better understood with reference to the following drawings, description and claims.

### BRIEF DESCRIPTION OF THE DRAWINGS

FIG. 1 is a front view of a breathing zone ventilation system, shown in-use with a restaurant bar;

FIG. 2 is a top plan view of the breathing zone ventilation system, shown in-use with a restaurant bar and tables;

FIG. 3 is a cross section of the invention air control module;

FIG. 4 is inlet end view of the invention air control module;

FIG. 5 is a top plan view of the air trays;

FIG. 6 is a side view of the breathing zone ventilation system, shown in-use with a table;

FIG. 7 is a side view of the breathing zone ventilation system, shown in-use with a table without 20, 22;

FIG. 8 is a top view of the breathing zone ventilation system, shown in-use with a table;

FIG. 9 is a front view of the breathing zone ventilation system, shown in-use with a table;

FIG. 10 is a side view of the breathing zone ventilation system, shown with removable air inlet;

FIG. 11 is a back view of the breathing zone ventilation system, shown in-use installed on airplane seats;

FIG. 12 is a side view of the breathing zone ventilation system, shown in-use with classroom desks;

FIG. 13 is a side view of the breathing zone ventilation system, shown in-use with pew/theater seating; and

FIG. 14 is a top plan view of the breathing zone ventilation system, shown in-use on office desks.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a breathing zone ventilation system that provides an air barrier for reducing the spread of airborne pathogens. The breathing zone ventilation (BZV) system provides for a protective air barrier between closely spaced occupants of an enclosed space, while preventing the dispersal of airborne contaminants within that same enclosed space.

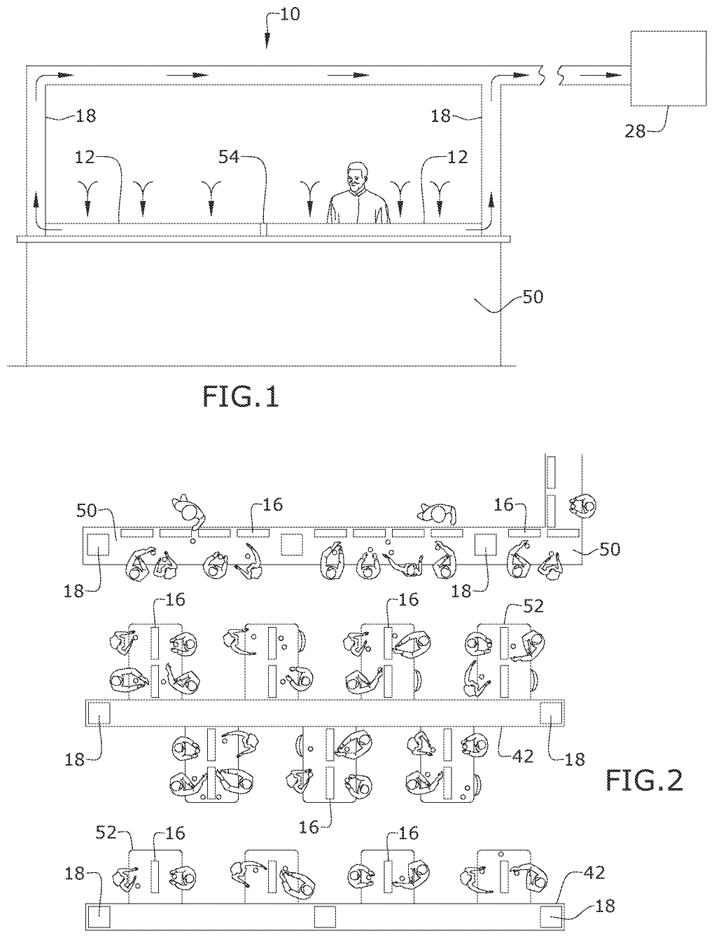

As seen in reference to the drawings of FIGS. 1 through 14, the breathing zone ventilation system of the present invention may be employed with furnishings commonly utilized in various applications and settings. Preferably, the breathing zone ventilation system 10 is employed within an enclosed space where people gather in close proximity, such as a restaurant, a classroom, an office conference room, and commercial carriers, including an airplane, a train, and a bus. As will be appreciated, the breathing zone ventilation system 10 of the present invention may also be employed in uncontained spaces to provide an effective air barrier between two occupants of a common seating area, such as a dining table.

A restaurant bar 50 according to an embodiment of the invention. The breathing zone ventilation (BZV) allows room air to enter the bar top air inlet 12 and be drawn through ductwork 18 to the air control module (ACM) 28. Ductwork connecting the air inlets 12 is concealed within the bar 50 and turns up in this view to connect with the ACM which is located inside the restaurant near the ceiling. Typically, the ductwork 18 would be concealed in columns, typical of what is sometimes found at restaurant bars, typically made of wood. The ductwork alternatively can be directed to the basement, if there is a basement (cellar).

A non-limiting embodiment of the breathing zone ventilation system in a restaurant bar setting. The breathing zone ventilation system 10 includes an air inlet 12 disposed along a longitudinal length of a bar 50. An air control module 28 draws an airflow through an air duct 18 that are in communication with the air inlet 12. The air duct 18 and air inlet 12 may be carried within the site furnishings, such as the bar 50 or a table 52. Components of the breathing zone ventilation system 10 may also be carried within a partition 42 separating adjacent seating areas within the setting. Alternatively, the breathing zone ventilation system 10 may be applied as retrofit to existing site furnishings. A grille 16 may be provided over the air inlet 12 to prevent the ingestion of objects with the airflow.

FIG. 2 shows a larger area of a restaurant with tabletops 52 and bar 50 with air inlet grilles 16 located in the preferred embodiment forward to draw in air and yet not create a breeze in the immediate space of the restaurant patron or their food and beverage. The ductwork in this view can go up or down depending on where the ACM is located. Partition walls 42 offer another location to install concealed ductwork. Platformed flooring (not shown) offers another location for concealing ductwork 18 as it moves to the ACM 28.

The ACM is a sealed enclosure 62, typically made of sheet metal, that comprises air inlet connections 26, an electric motor-powered blower 22, and at least one stack of air trays 64 and 66 which contain a torturous path of baffles 72. The air trays fit snuggly together to form a wall through which air flows. It is important that air does not blow around a gap in the air trays as this will create higher flow than desired at the exit 68. This view shows two stages of air trays. The number of stages will depend on the velocity of the blower, measured in cubic feet per minute (cfm). A stage of air purification can occur using a filter 20 shown here as a panel filter downstream of the air trays 64, 66. This filter can also be remote to the ACM for ease of accessibility to change it as desired.

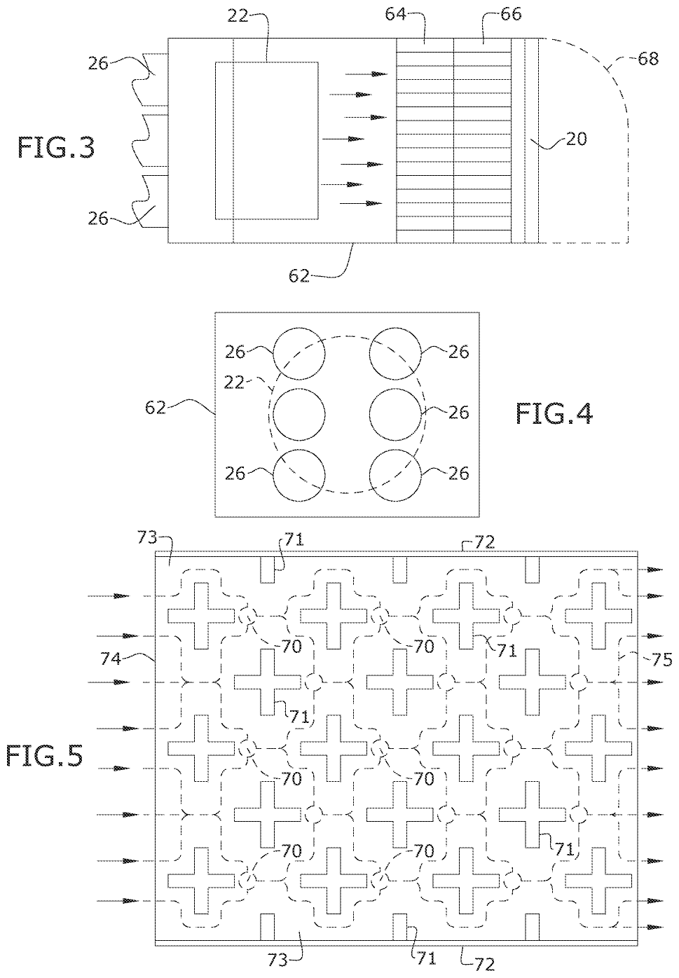

The air control module 28 is shown in the detail views of FIGS. 3-5. The air control module 28 includes a high-volume air blower 22 contained within an enclosure 62. A plurality of inlets 26 provide a fluid connection with the air duct 18 of the breathing zone ventilation system 10. FIG. 4 shows an end view of the ACM 28 with six connections 26 entering in this view. The number of connections will vary with the volume of air which the ACM 28 is handling. There also can be multiple ACMs 28 to service a given area or room.

One or more air tray stages 64, 66 are disposed across the airflow exiting the blower 22. A filter 20 is provided prior to the exit of the airflow from the housing 62 and a return line 68 to return the air to the enclosed space of the employment location of the breathing zone ventilation system. The plurality of air tray stages 64, 66 include an air tray enclosure, or frame 72, an inlet end 74 and an outlet end 75. A plurality of baffles 71 are disposed within the air tray enclosure 72 and are disposed in a spaced apart relation defining a labyrinth pathway for the airflow between the inlet end 74 and the outlet end 75. The labyrinth pathway is provided to disrupt and induce collisions 70 in the airflow to allow particulates carried within the airflow to precipitate out of the airflow and to slow the velocity of the airflow through the air control module 28.

FIG. 5 shows a top plan view of air trays having a plurality of baffles 71 attached to the bottom deck 76, side walls 74, an open sided inlet 78 and an open sided outlet 80. The baffles are arranged for to knock down flow velocity after it exist the blower 22. They are as tall as the side walls less the deck thickness so air has to pass alongside them on its transit from the inlet to the outlet. 70 shows collision locations where air travelling from one baffle 71 to another impacts. These impacts slow the air velocity. Air tray design optimization can be done with computer modelling referred to as computational fluid dynamics.

In operation, the fan/blower 22 is powered by electrical wiring or battery. It draws air into the inlet 12 from several feet away making sure that any germs or bacteria are drawn downwards and do not continue flight that microthermal currents would otherwise facilitate. The air passes through the filtration element 20 where germs are trapped. The airflow then exits the lower chamber 14. Preferably, the exiting air would be directed and or diffused. Air louvers can be mounted at the end of the lower chamberl4 to direct the air so that it is not blowing on a person or area where it can create a localized air disturbance that is not desirable.

The filter 20 is provided in the airflow exiting the one or more air tray stages 64, 66 to capture any remaining particulates. As will be appreciated, one of the filter 20 and the air tray stages 64, 66 may include a disinfecting treatment, such as an ultraviolet (UV) lighting or the like, to disinfect particulates, such as airborne viruses entrained within the airflow.

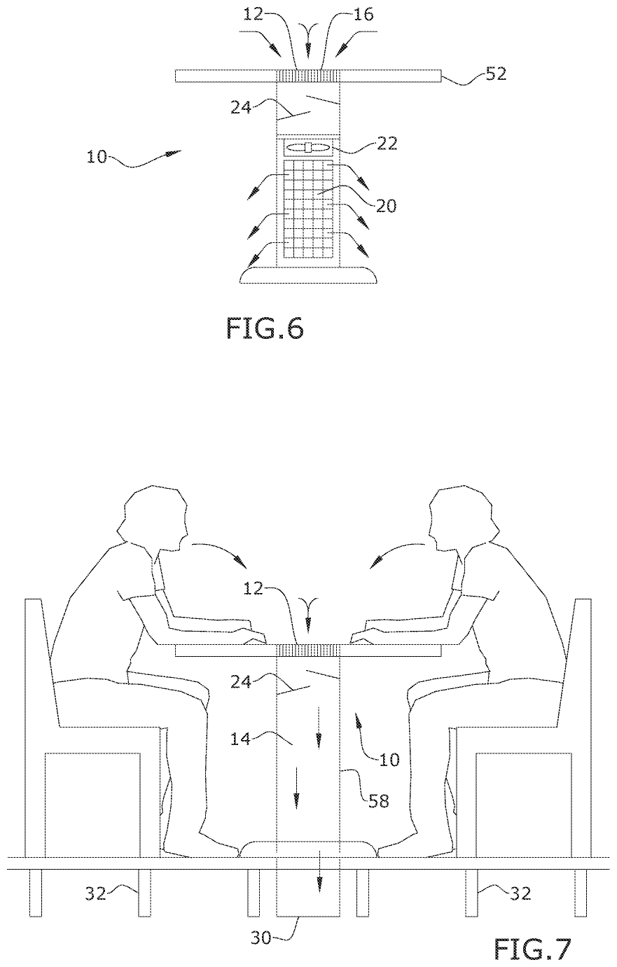

As seen in reference to FIGS. 5-9, a breathing zone ventilation system 10 of the present invention is shown integrated a table configuration. The breathing zone ventilation system 10 provides an air barrier between closely spaced occupants of the table 52. The air control module 28 is contained with a base or pedestal 58 of the table 52. The airflow is drawn through the inlets 12 by the blower 22. The grille 16 prevents objects on the table 52 from being drawn into the inlets 12. The airflow is carried through the baffles 24 of the air control module 28 and pass through the filter 20. In the non-limiting embodiment shown in FIG. 6, the airflow is returned to the immediate area of the table 52 after passing through the filter 20, where it is dispersed in a clean state to the surrounding areas within the enclosed space. The embodiment of FIG. 6 shows the invention using a standalone table, not connected to a central ACM as shown in FIGS. 1 and 2. In this embodiment the air velocities are typically lower than required in a centralized system so filter panels 20 can play the role of knocking down the flow exiting the table with air trays optional. The air enters the air inlet 12 a passing over the grille 16 on the tabletop 52. In this view the air travels past baffles 24 which serve to catch food or beverage that may enter the inlet 12 and to moderate sound levels from the blower 22. Air then exits the table past the filter panel 20 and flows at a very low flow back to the immediate area of the table.

In the non-limiting embodiment shown in reference to FIG. 7, the table 52 may be connected by a ductwork 30 in communication with a centralized blower (not shown). The airflow is similarly drawn in through the inlet 12 where it passes through the baffles 24 of the air stage trays 65, 66, carried within the pedestal 58 of the table 52. In this embodiment, the airflow from the baffles 25 is carried by the ductwork 30, which may be carried between floor joists 32. A table connected to a central ACM 28 at the duct connection 30 located here between floor joist 32. Here a chamber called a back chamber 14 serves as the air passage from the inlet 12 to the connecting duct 30. This connection 30 can also be to a platform that is situated under the table 52 and chairs to what would be a standalone arrangement not connected to a centralized ACM 28.

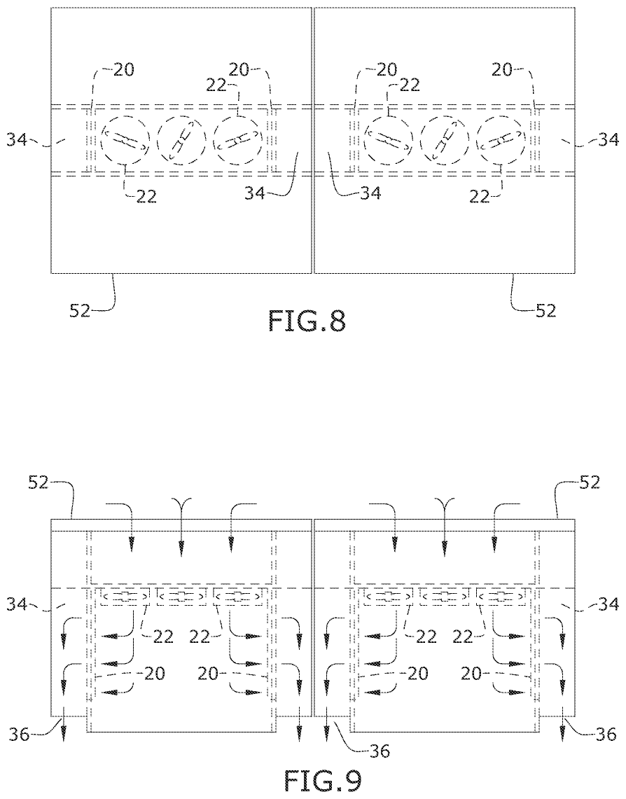

In the non-limiting embodiment shown in FIGS. 8 and 9, a modular configuration permits a plurality of tables 52 to be joined in an adjoining manner. Each of the tables 52 have an independent air control module 28 and associated blower 22. The outlets of the air control modules are connected with a recessed channel 34 in the table pedestal. An undercut 36 at a bottom of the recessed channel may disperse the clean area at a floor surface supporting the table 52 for dispersal into the room.

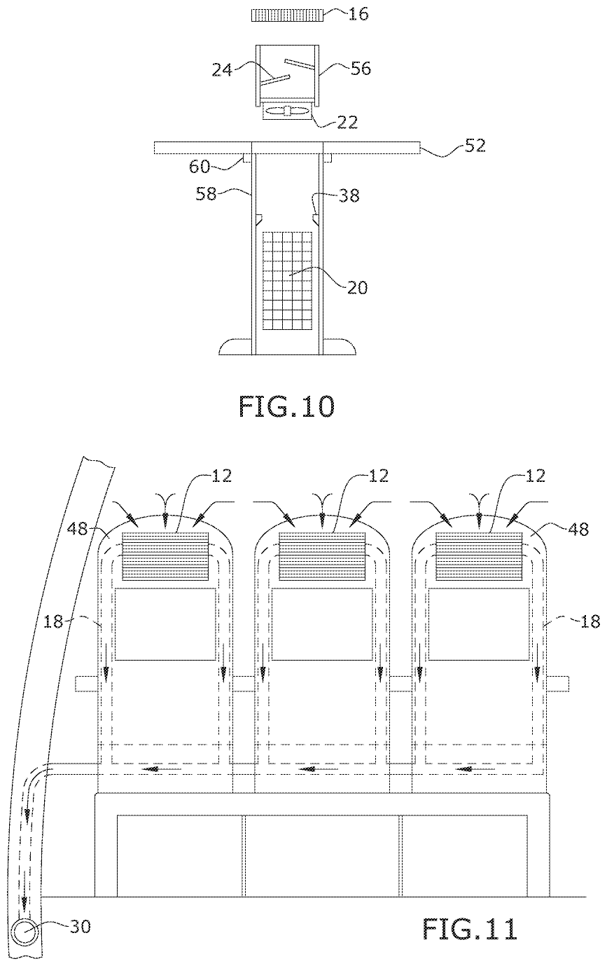

As seen in the non-limiting embodiment shown in FIG. 10, the air control module 56 may be removable from a top end of the table 52. In this embodiment, the grille 16 may be removed from the tabletop 52 and the air control module 56 may be withdrawn through the inlet 12. The air control module 56 may be supported on rails 38 within the pedestal of the table. In this embodiment, the filter 20 is in a downstream direction in the airflow from the blower 22.

An embodiment for a common carrier vehicle is shown in reference to FIG. 11. In this embodiment, the seatback 48 of the seat within the vehicle is fitted with an inlet 12 connected via an air duct 18 with an under-floor ventilation conduit 30, in communication with an ACM (not shown) connected with an air circulation system of the vehicle. The ACM may be contained in a cargo hold of the vehicle.

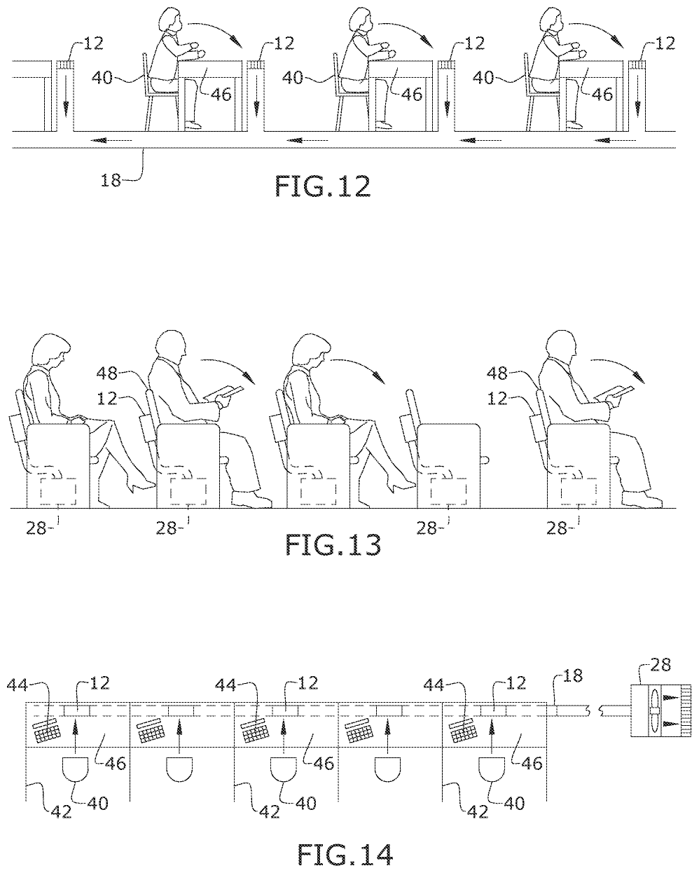

An embodiment for a classroom setting is shown in FIG. 12. In this embodiment inlets 12 are provided in front of each of a plurality of desks 46. The air inlets 12 communicate with the air control module (not shown) via the air duct 18. The air ducts 18 may be carried beneath a floor of the classroom.

An embodiment for a church or theater environment is shown in reference to FIG. 13. The seatback 48 of each pew 48 is provided with an inlet 12. In the embodiment shown, the inlet is in communication with an air control module 28 mounted beneath each pew 48. Depending on the configuration of the church or theater, the system 10 may alternatively utilize an underfloor duct 18, such as that shown for the common carrier or classroom environments.

An embodiment for an office setting is shown in FIG. 14. In the cubicle environment shown, each desk 46 is separated by a partition 42 and has a chair 40 for the occupant and a computing system 44. The duct 18 connects each of the plurality of inlets 12 from the desks 46 with the air control module 28. The air control module 28 cleans the airflow where it is returned within the closed room environment of the common office space.

The embodiments of this application involve the capture of air in any type of congregate space for the purpose of keeping infectious aerosols from spreading from one person to another even if seated in close proximity to each other. This involves the use of air moving equipment that would be independent of a space's Heating Ventilating and Air Conditioning HVAC system. It also includes air inlet grilles situated in the breathing zone of one or multiple people using higher velocity air. This high velocity air creates two air flow zones. First is that which is a perceptible vacuuming action at the entrance to the grille. The second is air drawn toward the first zone but does not create a breeze. This makes for more comfort in a space without “feeling a breeze”.

Embodiments are based on whether the breathing zone ventilation system 10 may be standalone or centralized. Standalone units are used when connecting ductwork to a centralized blower is not cost effective or preferred. Centralized systems are able to incorporate very high air flows, generally in excess of 2,000 cubic feet per minute (cfm) to connect multiple inlet grilles by using an enclosure that houses the blower and a downstream section with contiguous trays that are capable of knocking flow dramatically down using labyrinth-type torturous flow path. This flow knock down eliminates unwanted air turbulence that can transmit infectious aerosols around a room.

The blower and contiguous stacked air trays combine to form in a sealed enclosure called an air control module ACM. A final stage of filtration enhance removal of airborne bacteria and viruses. ACMs can be located in a ceiling, basement, utility room, or outside, either roof-mounted or on the side of the building. Drawing high velocity air from the inlet grilles through ductwork and then knocking it down to a whimper flow allows the introduction and use of blowers that can create enough flow to combat disease laden air. Returning the air volume back to the room from which it was drawn balances the pressure that otherwise would be in a vacuum condition making door operation and air ingress from minor gaps in windows and walls causing either hot or cold outside air to permeate into the room negatively impacting HVAC cost due to added heating or cooling requirements. Just as importantly, returning air back to the room rather than venting it outdoors, saves the cost of continuously heating or cooling the air.

It should be understood, of course, that the foregoing relates to exemplary embodiments of the invention and that modifications may be made without departing from the spirit and scope of the invention as set forth in the following claims.

What is claimed is:

1. A breathing zone ventilation system for providing a protective air barrier between closely spaced individuals within a local environment, comprising:
an air inlet disposed between an occupant of the local environment and another occupant of the local environment;
an air control module having a housing defining an interior cavity of the air control module, a blower, and at least one air tray stage, the housing having an inlet in communication with the air inlet, and an outlet;
the blower contained within the housing, the blower configured to develop a high velocity airflow into the air inlet, defining a downdraft air curtain into the air inlet; and
the at least one air tray stage disposed between the blower and the outlet, the at least one air tray stage having a frame defining an air tray enclosure, and a plurality of baffles disposed in a spaced apart relation within the air tray enclosure, the plurality of baffles defining a labyrinth pathway between the blower and the outlet.

2. The breathing zone ventilation system of claim 1, the air control module further comprising:
a filter interposed between the air tray stage and the outlet.

3. The breathing zone ventilation system of claim 2, wherein the air inlet is disposed in a tabletop of a table; and the air control module is mounted with a leg supporting the tabletop.

4. The breathing zone ventilation system of claim 3, wherein the outlet is vented to the local environment proximal to the table.

5. The breathing zone ventilation system of claim 4, further comprising:
an air duct coupled to the outlet, the air duct configured to communicate an exit airflow from the outlet to a point distal from the table.

6. The breathing zone ventilation system of claim 1, wherein the air control module is removably carried within a pedestal supporting the tabletop.

7. The breathing zone ventilation system of claim 6, further comprising:
a grille covering the air inlet.

8. A breathing zone ventilation system for providing a protective air barrier between closely spaced individuals within a local environment, comprising
a plurality of seats within the local environment;
an air inlet disposed on a seat back of each of the plurality of seats;
a duct, carried within the seatback is coupled with the air inlet;
an air control module having a housing defining an interior cavity of the air control module, a blower, and at least one air tray stage, the housing having an inlet in communication with the air inlet, and an outlet;
the blower contained within the housing, the blower configured to develop a high velocity airflow into the air inlet, defining a downdraft air curtain into the air inlet; and
the at least one air tray stage disposed between the blower and the outlet, the at least one air tray stage having a frame defining an air tray enclosure, and a plurality of baffles disposed in a spaced apart relation within the air tray enclosure, the plurality of baffles defining a labyrinth pathway between the blower and the outlet.

9. The breathing zone ventilation system of claim 8, the air control module further comprising:
a filter interposed between the air tray stage and the outlet of the air control module.

10. The breathing zone ventilation system of claim 9, wherein the air control module is mounted in a space beneath the plurality of seats.

11. The breathing zone ventilation system of claim 9, further comprising:
a duct interposed between the air inlet and the air control module.

12. The breathing zone ventilation system of claim 11, wherein the outlet is in communication with an air circulation system of the local environment.
